(19) United States
(12) Patent Application Publication
(10) Pub. No.: US 2006/0215242 A1
(43) Pub. Date: Sep. 28, 2006

(54) Communication device configured to automatically append an image to a message and method therefore

(76) Inventors: Mohammad Besharat, Lake Villa, IL (US); Faisal A. Haidar, Grayslake, IL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 11/088,518

(22) Filed: Mar. 24, 2005

(51) Int. Cl. H04N 1/46

(52) U.S. Cl. 358/540; 358/402

(57) ABSTRACT

The present invention relates to a method for dynamically appending an image to a message within a communication device by capturing the image (305) using an image capture means while composing the message and simultaneously appending the image to the message (320). The present invention also relates to all communication devices (106, 205) equipped with an image capture means and a messaging means (110, 210) adapted to append the image to the message when the image is captured while composing the message.

### FIELD OF INVENTION

The present invention generally relates to communication devices with messaging and image capture capabilities, and more particularly to a communication device configured to automatically append an image to a message and associated method of operation.

### BACKGROUND OF THE INVENTION

Communication devices today are capable of multiple methods of communication including transmitting and receiving messages including electronic mail messages, short message service (SMS) messages, video messages, text messages, data messages, multimedia messaging service messages, and the like.

With the progress of technology, communication devices are becoming increasingly advanced and capable of performing a variety of tasks. A user of a communication device expects additional and more complex functionalities to be provided in the communication device while keeping the device compact.

As communication devices continue to evolve, device capabilities continue to expand. One such capability is connectivity to imaging devices such as still-imaging and video cameras. For example, there are still-image and video camera accessories that can be connected to a cellular telephone. Some devices further provide capability to receive images such as photographs taken by other electronic devices such as a cellular telephone receiving a photograph from a personal computer. Further, some device manufacturers are offering communication devices with built-in imaging devices including still image and/or video cameras. Once the images are stored on the communication device, the device user can view them on the display and utilize the images in other available applications such as backgrounds, standby screens, contact lists, and the like. For example, users of such electronic devices often use image capturing devices such as video recorders, camcorders, and still-image cameras to capture images while traveling or attending social events on their mobile devices. Cameras are also used in video conferencing and providing enhancements to traditional communications with other users around the world.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a mobile device with an integrated camera.

FIG. 2 illustrates a computing device with an attached camera.

FIG. 3 is an exemplary flow chart of the operation of a communication device in accordance with one embodiment of the invention.

FIG. 4 is an exemplary flow chart of the operation of a communication device in accordance with another embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to a method of automatically appending an image captured while composing a message, to the message; and a communication device implementing the method of operation. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of automatically appending an image captured while composing a message, to the message described herein. The non-processor circuits may include, but are not limited to, a radio receiver, a radio transmitter, signal drivers, clock circuits, power source circuits, and user input devices. As such, these functions may be interpreted as steps of a method to perform operations to automatically append an image captured while composing a message, to the message. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

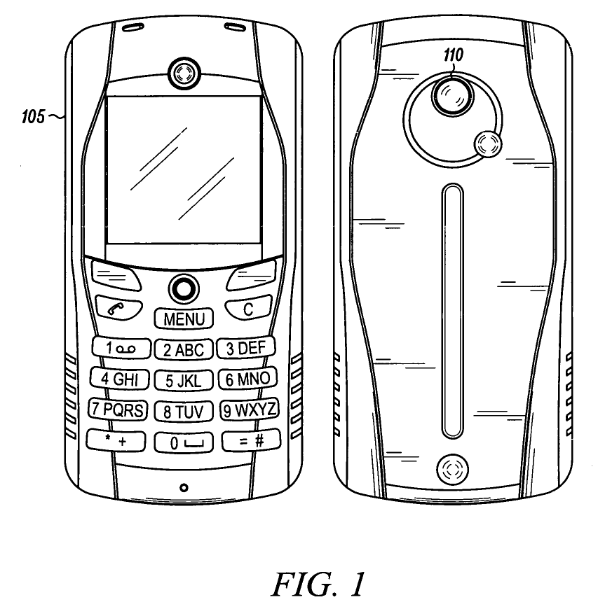

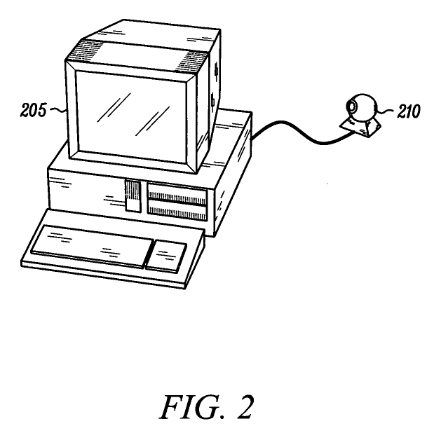

Pursuant to one embodiment, FIG. 1 and FIG. 2 illustrate two examples of electronic devices with image capturing means. It will be appreciated by those of ordinary skill in the art that any electronic device including communication and imaging means can incorporate the invention as described herein. The communication device, for example, can be a cellular telephone, a cordless telephone, a wired landline telephone, a personal communicator, or an equivalent. Similarly, the communication device can be a PDA (personal digital assistant), a portable personal computer, or an equivalent. In the following description, the term “communication device” and/or “electronic device” refers to any of the devices mentioned above or an equivalent device with communication capability.

Electronic devices such as mobile telephones, laptops, personal digital assistants (PDAs) are often equipped with still or video cameras to enable users to capture images. For example, the recent trend of having integrated cameras within mobile phones and PDAs provides users the ability to capture images while on the move. People no longer have to carry a separate camera to a party or a social gathering to capture images at the event. The mobile phone 105 with the integrated camera 110 serves as both a communications device as well as a camera to capture quick images. More advanced computing devices such as portable computers 205 and desktop computers can also be connected to external cameras 215 for users to capture images or even use the cameras for video-conferencing.

Messaging applications such as electronic mail message applications on advanced electronic devices such as laptops is common. Mobile devices, in addition to voice-based communication, also provide messaging applications using various forms of messages such as short message service (SMS) message, video message, text message, data message and multimedia messaging service message are often used by users to send messages to other users around the world. For example, a user with a mobile phone can send a short messaging service (SMS) message to another user using an SMS application on the mobile device. Recent developments enable users to sends pictures, tones, videos and other forms of media using messaging applications to other users. This is enabled with the use of multimedia messaging service that lets users send multimedia messages to other users. In mobile devices such as cell phones 105, cell phone vendors provide an integrated camera for users to capture images.

As per one embodiment of the invention, images captured using the camera while a message is being composed, can be simultaneously appended to the message and sent. A user of a mobile device 105 can launch a messaging application to send a message to another user. While composing such a message, the user may wish to click one or more images of an object to send to the other user. For example, a user of the mobile device may be on a vacation and messaging another friend in his hometown using the multimedia messaging service. While messaging the friend, the user of the mobile device may wish to send him an image of his surroundings. While composing the message, the user can enable an image capture means and capture an image of his surroundings using the image capture means. Every image captured can be simultaneously appended to the message being sent.

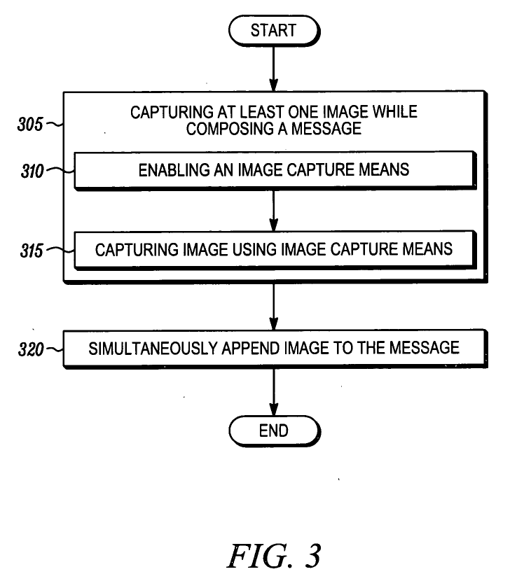

FIG. 3 is an exemplary flow chart of the operation of a communication device in accordance with one embodiment of the invention. As illustrated, the operation begins with Step 305 in which a user of the communication device activates an image capturing means while composing a message on the communication device. This involves, enabling an image capture means, step 310 and capturing the image using the image capture means, step 315. The image capture means can comprise any combination of a camera, a camera application, a video camera, a video camera application, or an equivalent. The image is simultaneously appended to the message, step 320. The user may also wish to capture more that one image. In this case, each image can be subsequently appended to the message. The message can comprise one of an electronic mail message, a video message, a text message, a data message, a multimedia messaging service message, or an equivalent. In one embodiment, a user can be provided with an option in the form of a confirmation box or a form of a graphical user interface to choose whether he wishes to append the image to the message. The user can also be provided with an option to launch an image editing application to edit the image prior to appending the image to the message.

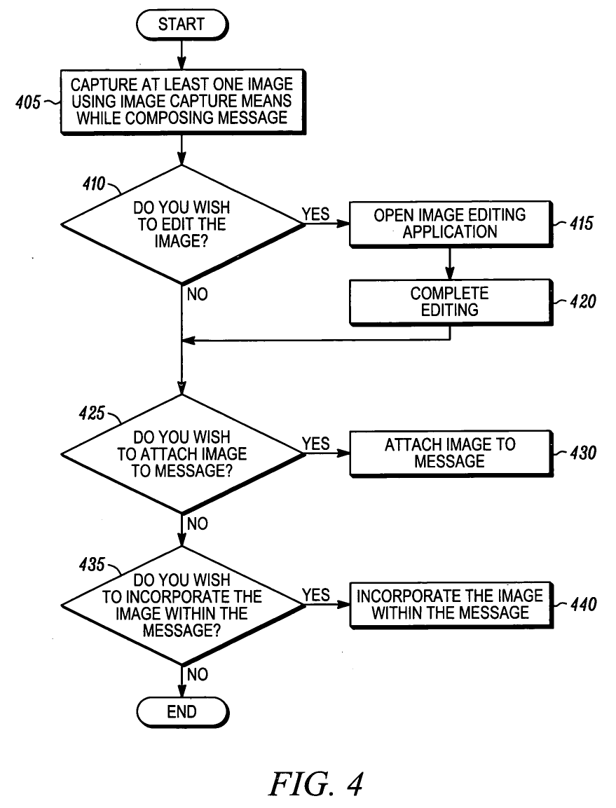

FIG. 4 is an exemplary flow chart of the operation of a communication device in accordance with another embodiment of the invention. The operation begins with Step 405 in which a user captures an image while composing the message on the communication device. The communication device can be a mobile phone, PDA, laptop, desktop or any device equipped with a messaging application and an image capture means. The image capture means can comprise any combination of a camera, a camera application, a video camera, a video camera application, and the like. In one embodiment, the user is provided with an option to edit the image, step 410, before simultaneously appending the image to the message. The user optionally can be provided with the choice to edit the image for every image he captures and wishes to append to the message. For example, the mobile telephone can contain an image editing application to make various modifications to the image captured. The user interface provided to receive the input from the user can be coupled to the image editing means for editing the image before it is appended to the message. If the user wishes to edit the image, an image editing application is launched, step 415, and on carrying out the modifications, step 420, the user is again provided with an option to attach the image to the message, 425 or incorporate the image within the message, step 435. Based on the user's choice, each image captured can then be attached to the message, step 430 or incorporated within the message, step 440. The messaging means is correspondingly adapted to enable the image to be attached to the message or incorporated within the message. Those skilled in the art will appreciate that some images can be attached and some incorporated within the message based on the user preference and these embodiments are within the scope of the present invention. The choices provided to the user can be in the form of a dialog box or a user interface that could be coupled to the messaging means to receive the user input before appending the image to the message. In one embodiment, the image capture means and the messaging means are algorithms contained within one software application.

The process as described herein provides a user with the ability to launch an image capture means while composing a message and further, an option to simultaneously attach or incorporate the image captured with the image capture means within the message.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for automatically appending at least one image to a message within a communication device, the method comprising the steps of:
capturing the image while composing the message; and
simultaneously appending the image to the message.

2. A method as recited in claim 1 further comprising the step of:
enabling an image capture means,
wherein the capturing step comprises capturing the image using the image capture means.

3. A method as recited in claim 2, wherein the image capture means comprises one or more means selected from the group comprising a camera, a camera application, a video camera, and a video camera application.

4. A method as recited in claim 1, further comprising the step of:
receiving a user input prior to the appending step.

5. A method as recited in claim 1, wherein the appending step comprises attaching the image to the message.

6. A method as recited in claim 1, wherein the appending step comprises incorporating the image within the message.

7. A method as recited in claim 1 further comprising the step of:
editing the image prior to the appending step.

8. A method as recited in claim 7, wherein the communication device further comprises an image editing application, and wherein the editing step comprises:
editing the image using the image editing application.

9. A method as recited in claim 1, wherein the message is one or more messages selected from a group comprising an electronic mail message, a video message, a text message, a data message, and a multimedia messaging service message.

10. A method as recited claim 1, wherein the communication device comprises a messaging means and an image capture means.

11. A communication device configured to automatically append at least one image to a message, the communication device comprising:
an image capture means for capturing the image; and
a messaging means adapted to append the image to the message when the image is captured while composing the message.

12. A communication device as recited in claim 11, wherein the image capture means comprises one or more means selected from the group comprising a camera, a camera application, a video camera, and a video camera application.

13. A communication device as recited in claim 11, wherein the image capture means and the messaging means are algorithms contained within one software application.

14. A communication device as recited in claim 11, wherein the messaging means is adapted to attach the image to the message.

15. A communication device as recited in claim 11, wherein the messaging means is adapted to incorporate the image within the message.

16. A communication as recited in claim 11, further comprising:
a user interface coupled to the messaging means for receiving a user input to append the image to the message.

17. A communication device as recited in claim 16 further comprising an image editing means,
wherein the user interface is further coupled to the image editing means for editing the image to be appended to the message.

18. A communication device as recited in claim 11, wherein the message is one or more messages selected from a group comprising an electronic mail message, a video message, a text message, a data message, and a multimedia messaging service message.

19. A communication device as recited in claim 11, wherein the image capture means is externally coupled to the communication device.
